(19) United States
(12) Patent Application Publication
(10) Pub. No.: US 2024/0184347 A1
(43) Pub. Date: Jun. 6, 2024

(54) INFORMATION PROCESSING APPARATUS AND CONTROL METHOD

(71) Applicant: Lenovo (Singapore) Pte. Ltd., Singapore (SG)

(72) Inventors: Masashi Nishio, Kanagawa (JP); Kazuhiro Kosugi, Kanagawa (JP)

(73) Assignee: Lenovo (Singapore) Pte. Ltd., Singapore (SG)

(21) Appl. No.: 18/466,592

(22) Filed: Sep. 13, 2023

(30) Foreign Application Priority Data
Oct. 21, 2022 (JP) 2022-168995

(51) Int. Cl. G06F 1/3231; G06T 7/73; G06V 40/16

(52) U.S. Cl. CPC G06F 1/3231; G06T 7/73; G06V 40/161

(57) ABSTRACT

An information processing apparatus includes: a first detection device for detecting a person in a predetermined direction; a second detection device for detecting the person in the predetermined direction with higher power consumed than that of the first detection device; a memory which temporarily stores a program of a system; and a processor which controls the operating state of the system by executing the program. The processor boots the system from a standby state based on first detection processing to detect the person in the predetermined direction using the first detection device, and in a state where the system is booted, the processor performs second detection processing to detect the person in the predetermined direction using the second detection device, and stops the second detection processing depending on the state of the detected person to detect the person in the predetermined direction.

### CROSS-REFERENCE TO RELATED APPLICATIONS

This application claims priority to Japanese Patent Application No. 2022-168995 filed on Oct. 21, 2022, the contents of which are hereby incorporated herein by reference in their entirety.

### BACKGROUND

### Technical Field

The present invention relates to an information processing apparatus and a control method.

### Description of Related Art

There is an apparatus which makes a transition to a usable state when a person approaches or to a standby state in which functions except some of the functions are stopped when the person leaves. For example, in Japanese Unexamined Patent Application Publication No. 2016-148895, it is detected whether a person is approaching or has moved away using an infrared sensor.

In recent years, with the development of computer vision and the like, detection accuracy when detecting a face from an image has been getting higher. Therefore, person detection by face detection is also performed instead of person detection by the infrared sensor. For example, in a case of a ToF (Time of Flight) sensor using infrared light, since a person is detected by measuring a distance to the person based on the time until emitted infrared light comes back after being reflected on the person, the infrared light is reflected and comes back regardless of a person or an object other than the person. For example, although there is a method for determining whether it is a person or an object other than the person based, for example, on the presence or absence of minute movement of the object, the use of face detection can detect a person more accurately. For example, since the detection of a person by face detection can also detect the orientation of a face in addition to simply detecting the person, control according to the orientation of the face (facing forward, facing sideways, or the like) can also be pertained.

Although the detection of a person by face detection can detect the person accurately, power consumption is high compared to the detection of a person using a conventional ToF sensor. Therefore, there is proposed a method of combining the detection of a person by face detection and the detection of a person using the ToF sensor in a manner to use the ToF sensor in a standby state in which power consumption is particularly required to be reduced. However, this method does not contribute to reduced power consumption in an operating state after being booted from the standby state though the power consumption is reduced in the standby state.

### SUMMARY

The present invention has been made in view of the above circumstances, and it is an object thereof to provide an information processing apparatus and a control method capable of detecting a person accurately while reducing power consumption.

The present invention has been made to solve the above problem, and an information processing apparatus according to the first aspect of the present invention includes: a first detection device for detecting a person in a predetermined direction; a second detection device for detecting the person in the predetermined direction with higher power consumed than that of the first detection device; a memory which temporarily stores a program of a system; and a processor which controls the operating state of the system by executing the program, wherein the processor boots the system from a standby state based on first detection processing to detect the person in the predetermined direction using the first detection device, and in a state where the system is booted, the processor performs second detection processing to detect the person in the predetermined direction using the second detection device, and stops the second detection processing using the second detection device depending on the state of the detected person to detect the person in the predetermined direction by the first detection processing using the first detection device.

The above information processing apparatus may also be such that when the motion of the detected person is a predetermined threshold value or more in the state where the system is booted, the processor detects the person in the predetermined direction by the second detection processing using the second detection device, or when the motion of the detected person is less than the predetermined threshold value, the processor stops the second detection processing using the second detection device to detect the person in the predetermined direction by the first detection processing using the first detection device.

The above intonation processing apparatus may further be such that after the second detection processing is stopped in the state where the system is booted, when the motion of the person detected by the first detection processing is the predetermined threshold value or more, the processor executes the second detection processing using the second detection device to detect the person in the predetermined direction.

Further, the above information processing apparatus may be such that the processor stops the first detection processing using the first detection device when detecting the person in the predetermined direction by the second detection processing using the second detection device.

Further, the above information processing apparatus may be such that the first detection device includes a ToF (Time of Flight) sensor or a radar sensor which measures a distance to an object in the predetermined direction, and in the first detection processing, the processor detects a person by measuring the distance to the object in the predetermined direction using the first detection device.

Further, the above information processing apparatus may be such that the second detection device includes an imaging sensor which images the predetermined direction, and in the second detection processing, the processor detects an area of a face image from among captured images obtained by imaging the predetermined direction using the second detection device to detect a person.

Further, the above information processing apparatus may be such that in the second detection processing, the processor further detects the orientation of a face in the detected face image to control the operating state of the system according to the detected orientation of the face.

Further, the above information processing apparatus may be such that in the second detection processing, the processor performs face authentication processing based on the detected face image to control the operating state of the system according to the authentication result.

A control method according to the second aspect of the present invention is a control method for an information processing apparatus including: a first detection device for detecting a person in a predetermined direction; a second detection device for detecting the person in the predetermined direction with higher power consumed than that of the first detection device; a memory which temporarily stores a program of a system; and a processor which controls the operating state of the system by executing the program, the control method including: a step of causing the processor to boot the system from a standby state based on first detection processing to detect the person in the predetermined direction using the first detection device; and a step of causing the processor to perform second detection processing in order to detect the person in the predetermined direction using the second detection device in a state where the system is booted, and to stop the second detection processing using the second detection device depending on the state of the detected person in order to detect the person in the predetermined direction by the first detection processing using the first detection device.

The above-described aspects of the present invention can detect a person accurately while reducing power consumption.

### BRIEF DESCRIPTION OF THE DRAWINGS

FIGS. 1A-1C are diagrams each for describing an outline of HPD processing of an information processing apparatus according to an embodiment.

FIG. 2 is a diagram illustrating an example of a person detection range of the information processing apparatus according to the embodiment.

FIG. 3 is a diagram illustrating an example of transitions of operating states and detection processing according to the embodiment.

FIG. 4 is a perspective view illustrating a configuration example of the appearance of the information processing apparatus according to the embodiment.

FIG. 5 is a schematic block diagram illustrating an example of the hardware configuration of the information processing apparatus according to the embodiment.

FIG. 6 is a schematic block diagram illustrating an example of the functional configuration of the information processing apparatus according to the embodiment.

FIG. 7 is a flowchart illustrating an example of HPD control processing according to the embodiment.

FIG. 8 is a graph illustrating power consumption reduction effects according to the embodiment.

### DETAILED DESCRIPTION

An embodiment of the present invention will be described below with reference to the accompanying drawings.

[Outline]

First, the outline of an information processing apparatus 1 according to the embodiment will be described. The information processing apparatus 1 according to the present embodiment is, for example, a laptop PC (Personal Computer). Note that the information processing apparatus 1 may also be any other font of intonation processing apparatus such as a desktop PC, a tablet terminal, or a smartphone.

The information processing apparatus 1 can make a transition at least between a normal operating state (power-on state) and a standby state as system operating states. The normal operating state is an operating state capable of executing processing without being particularly limited, which corresponds, for example, to 50 state defined in the ACPI (Advanced Configuration and Power Interface) specification. The standby state is a state in which at least part of system processing is limited and power consumption is lower than that in the normal operating state. For example, the standby state may be the standby state or a sleep state, modern standby in Windows (registered trademark), or a state corresponding to S3 state (sleep state) defined in the ACPI specification. Further, a state in which at least the display of a display unit appears to be OFF (screen OFF), or a screen lock state may be included as the standby state. The screen lock is a state in which an image preset to make a content being processed invisible (for example, an image for the screen lock) is displayed on the display unit, that is, an unusable state until the lock is released (for example, until the user is authenticated).

In the following, a transition of the system operating state from the standby state to the normal operating state may also be called “boot.” In the standby state, since the activation level is generally lower than that in the normal operating state, the boot of the system of the information processing apparatus 1 leads to the activation of the operation of the system in the information processing apparatus 1.

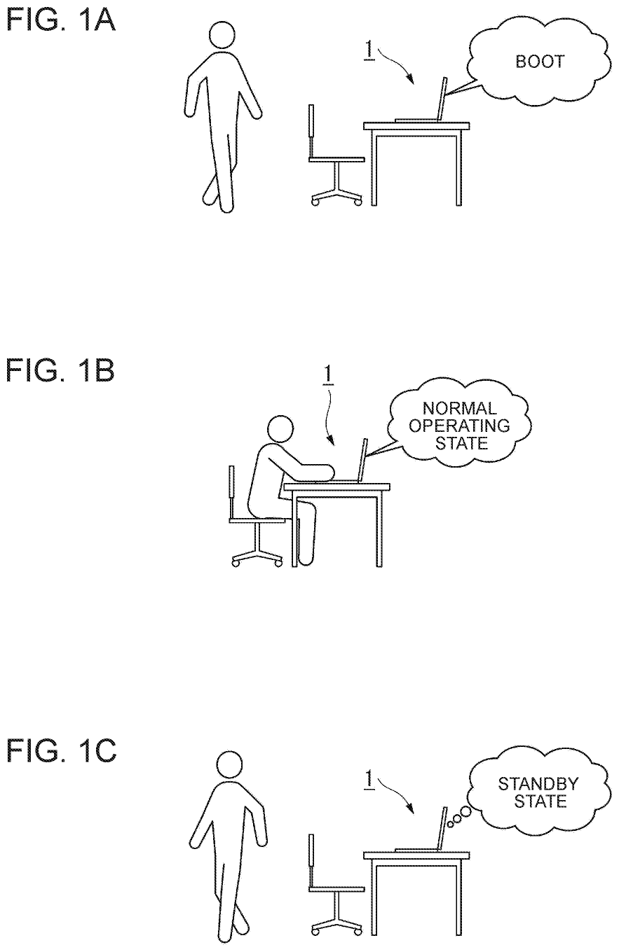

FIGS. 1A-1C are diagrams each for describing the outline of HPD processing of the information processing apparatus 1 according to the present embodiment. The information processing apparatus 1 detects a person present in the neighborhood of the information processing apparatus 1. This processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1A, when detecting a change from a state where no person is present in front of the information processing apparatus 1 (Absence) to a state where a person is present (Presence), that is, when detecting that a person has approached the information processing apparatus 1 (Approach), the information processing apparatus 1 determines that a user has approached and automatically boots the system to make a transition to the normal operating state. Further, in a state where a person is present in front of the information processing apparatus 1 (Presence) as illustrated in FIG. 1B, the intonation processing apparatus 1 determines that the user is present and continues the normal operating state. Then, as illustrated in FIG. 1C, when detecting a change from the state where the person is present in front of the information processing apparatus 1 (Presence) to a state where no person is present (Absence), that is, when detecting that the person has left the information processing apparatus 1 (Leave), the information processing apparatus 1 determines that the user has left and causes the system to make a transition to the standby state.

The information processing apparatus 1 detects the presence of a person within a predetermined range in front of the information processing apparatus 1.

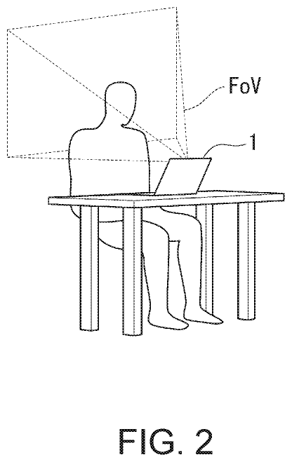

FIG. 2 is a diagram illustrating an example of a person detection range of the intonation processing apparatus 1 according to the present embodiment. In the illustrated example, a detection range FoV (Field of View: detection viewing angle) in front of the information processing apparatus 1 is a person-detectable range.

As person detection methods, the information processing apparatus 1 has a first detection method using ToF (Time of Flight) and a second detection method using face detection. As the first detection method, the information processing apparatus 1 includes a ToF sensor configured to include a light-emitting part for emitting infrared light forward and a light-receiving part for receiving reflected light which is the infrared light returned after emitted and reflected on the surface of an object to detect light received by the light-receiving part at every predetermined sampling period (for example, 1 Hz) in order to detect a distance to the object (for example, a person) using a ToF method for converting a time difference from light emission to light reception into a distance. Thus, the information processing apparatus 1 detects the presence of a person in the detection range FoV. The detection range FoV corresponds to a detection range detectable by the ToF sensor.

Further, as the second detection method, the information processing apparatus 1 includes an imaging unit for imaging forward to detect an area of a face image (hereinafter called a “face area”) with a face captured therein from a captured image in order to detect the presence of a person in the detection range FoV. The detection range FoV corresponds to an angle of view at which the information processing apparatus 1 captures images. Note that the detection range FoV detectable by the ToF sensor and a detection range FoV corresponding to the angle of view at which the information processing apparatus 1 captures images are both predetermined forward ranges of the information processing apparatus 1, but both forward ranges do not have to match each other.

In the second detection method using face detection, it is possible to detect a face orientation and perform face authentication and the like in addition to simply detecting the presence of a person. For example, the information processing apparatus 1 detects the face orientation such as whether the face is facing forward or sideways. When the face is facing sideways (that is, when the user is looking away), the information processing apparatus 1 can reduce the screen brightness to reduce power consumption. Further, the information processing apparatus 1 can also perform face authentication of the person present in front of the information processing apparatus 1 to determine whether or not the person is an authorized user.

Thus, the second detection method using face detection has the advantages of high detection accuracy and many detection items when detecting the presence of the user compared to the first detection method using the ToF sensor. On the other hand, the second detection method is high in power consumption compared to the first detection method. Therefore, the information processing apparatus 1 executes processing basically using the first detection method in the standby state with reduced power consumption required. Further, the information processing apparatus 1 executes processing using the second detection method in the normal operating state only when the second detection method is required, and executes processing using the first detection method otherwise.

In the following, processing to detect the presence of a person by the first detection method using the ToF sensor is called “low-power detection processing.” On the other hand, processing by the second detection method using face detection to detect the presence of a person, detect the orientation of a face of the present person, perform face authentication of the present person (determine whether or not the person is an authorized user), and the like is called “high-power detection processing.”

Note that the low-power detection processing is not limited to the detection using the ToF sensor, and it may also be processing to detect a distance to an object (for example, a person) using a radar sensor to detect a distance to an object present in front by emitting radio waves forward and receiving reflected waves of the emitted radio waves.

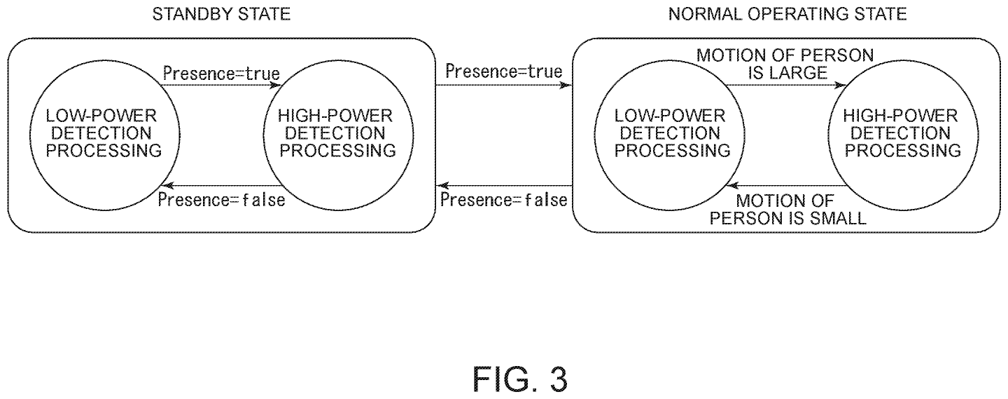

Here, the transition of the system operating state and the transition between the low-power detection processing and the high-power detection processing will be described with reference to FIG. 3.

FIG. 3 is a diagram illustrating an example of transitions of the operating states and the detection processing according to the present embodiment. In the standby state, the information processing apparatus 1 detects the presence of a person by the low-power detection processing. When detecting the presence of a person by the low-power detection processing (Presence=true), the intonation processing apparatus 1 switches to the high-power detection processing to detect the presence of the person. The information processing apparatus 1 determines whether or not the present person is an authorized user by the high-power detection processing, and when the present person is not the authorized user, the information processing apparatus 1 determines that the authorized user is not present (Presence=false), and returns to the low-power detection processing. On the other hand, when determining that the authorized user is present by the high-power detection processing (Presence=true), the information processing apparatus 1 boots the system from the standby state to make the transition to the normal operating state.

In the normal operating state, the information processing apparatus 1 detects the presence of a person, detects the orientation of a face of the present person, performs face authentication of the present person (determines whether or not the person is an authorized user), and the like by the high-power detection processing only when the high-power detection processing is required. Then, when the high-power detection processing is not required, the information processing apparatus 1 uses the low-power detection processing. For example, the information processing apparatus 1 selects use of the high-power detection processing or use of the low-power detection processing depending on the state of the detected person. Specifically, when the motion of the detected person is large, since the state of the person (the position of the person, the orientation of the face, and the like) is likely to change, the information processing apparatus 1 selects the high-power detection processing to be able to detect the change. On the other hand, when the motion of the detected person is small, since the state of the person (the position of the person, the orientation of the face, and the like) is stable, the information processing apparatus 1 selects the low-power detection processing.

For example, in the normal operating state, when determining that the motion of the person is a predetermined threshold value or more based on a change in the distance to or position (direction) of the person while detecting the presence of the person by the low-power detection processing, the information processing apparatus 1 switches from the low-power detection processing to the high-power detection processing. On the other hand, in the normal operating state, when determining that the motion of the person is less than the predetermined threshold value based on a change in the size of the face area or the orientation of the face while detecting the presence of the person by the high-power detection processing, the information processing apparatus 1 switches from the high-power detection processing to the low-power detection processing. Further, in the normal operating state, when the presence of the person is no longer detected by the low-power detection processing or the high-power detection processing (Presence=false), the intonation processing apparatus 1 detects that the person has left (Leave) and makes the transition to the standby state.

Here, when switching from the high-power detection processing to the low-power detection processing, the information processing apparatus 1 stops the high-power detection processing. Thus, power consumed in the high-power detection processing can be reduced after switching to the low-power detection processing. On the other hand, when switching from the low-power detection processing to the high-power detection processing, the information processing apparatus 1 may execute the high-power detection processing without stopping the low-power detection processing, or may stop the low-power detection processing. Since the power consumption of the low-power detection processing is lower than that of the high-power detection processing, the difference in power consumption between when the low-power detection processing is stopped and when the low-power detection processing is not stopped is small. If it is required to reduce power consumption even a little bit more, the low-power detection processing may be stopped while the high-power detection processing is being executed. Note that when the low-power detection processing is not stopped while the high-power detection processing is being executed, the information processing apparatus 1 may perform various determinations and controls based on both detection results of the high-power detection processing and the low-power detection processing.

The configuration of the information processing apparatus 1 according to the present embodiment will be described in detail below.

[Appearance Configuration of Information Processing Apparatus]

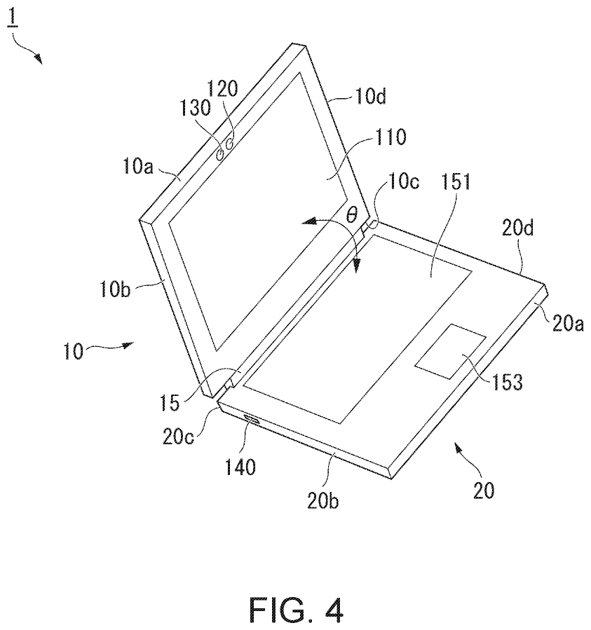

FIG. 4 is a perspective view illustrating an appearance configuration example of the information processing apparatus 1 according to the present embodiment.

The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “0” in FIG. 4.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ =0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 4 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the information processing apparatus 1, and the information processing apparatus 1 is often used in a state where the open angle is typically about 0=100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. The imaging unit 120 is configured to include an image sensor for capturing a visible light image, having the functionality of a visible light camera (RGB camera). For example, the imaging unit 120 is arranged on the side of the side face 10a in the peripheral area of the display unit 110. Note that the position at which the imaging unit 120 is arranged is just an example, and it may be elsewhere as long as the imaging unit 120 can capture an image in a direction (frontward) to face the inner face of the first chassis 10.

In the open state, the imaging unit 120 images a predetermined imaging range in the direction (frontward) to face the inner face of the first chassis 10. The predetermined imaging range is a range of angles of view defined by an imaging element (imaging sensor) included in the imaging unit 120 and an optical lens provided in front of the imaging surface of the imaging element, which corresponds to the detection range FoV of a person (face) illustrated in FIG. 2. For example, the imaging unit 120 can capture an image including a person present in front of the information processing apparatus 1.

Further, a ToF sensor 130 is provided in the peripheral area of the display unit 110 on the inner face of the first chassis 10. In the example illustrated in FIG. 4, the imaging unit 120 and the ToF sensor 130 are arranged side by side on the side of the side face 10a in the peripheral area of the display unit 110. However, the imaging unit 120 and the ToF sensor 130 may also be arranged anywhere in the peripheral area of the display unit 110 on the inner face of the first chassis 10, respectively.

The ToF sensor 130 emits infrared light forward and receives reflected light of the emitted infrared light to detect a distance to an object (for example, a person) present in front by using the ToF method. For example, in the open state, the ToF sensor 130 detects the distance to and position (direction) of an object (for example, a person) present within the detection range FoV in the direction (frontward) to face the inner face of the first chassis 10. Note that a radar sensor may be provided instead of the ToF sensor 130.

A power button 140 is provided on the side face 20b of the second chassis 20. The power button 140 is an operating element used by the user to give an instruction to power on or power off, make the transition from the standby state to the normal operating state, make the transition from the normal operating state to the standby state, or the like. Further, a keyboard 151 and a touch pad 153 are provided on the inner face of the second chassis 20 as an input device to accept user's operation input. Note that a touch sensor may also be provided as the input device instead of or in addition to the keyboard 151 and the touch pad 153, or a mouse and an external keyboard may be connected. When the touch sensor is provided, an area corresponding to the display surface of the display unit 110 may be constructed as a touch panel to accept operations. Further, a microphone used to input voice may be included in the input device.

Note that in the closed state where the first chassis 10 and the second chassis 20 are closed, the display unit 110, the imaging unit 120, and the ToF sensor 130 provided on the inner face of the first chassis 10, and the keyboard 151 and the touch pad 153 provided on the inner face of the second chassis 20 are covered with each other's chassis faces, respectively, and put in a state of being disabled from fulfilling the functions.

[Hardware Configuration of Information Processing Apparatus]

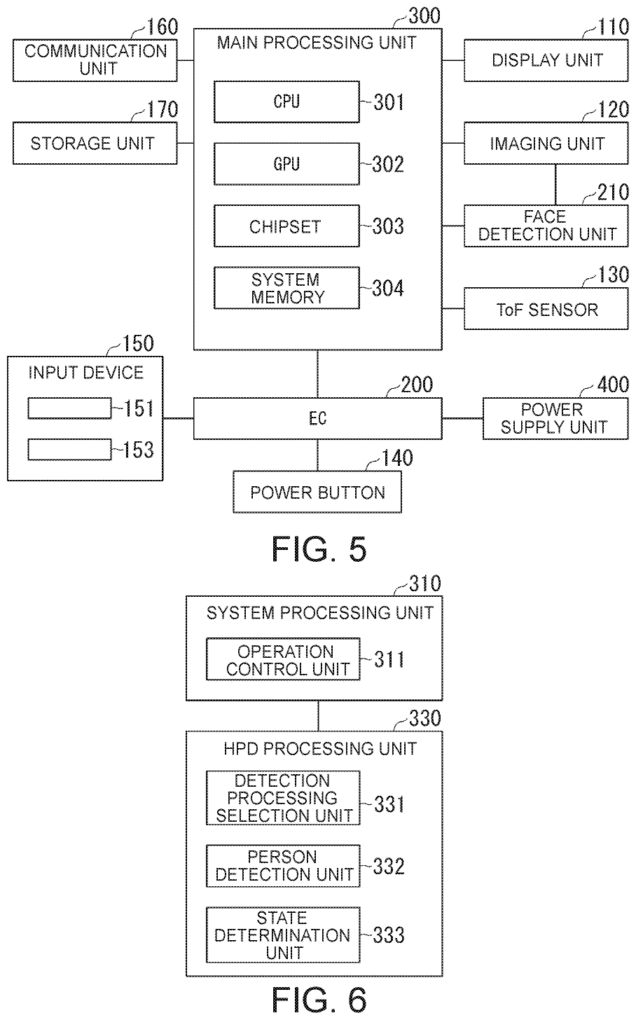

FIG. 5 is a schematic block diagram illustrating an example of the hardware configuration of the intonation processing apparatus 1 according to the present embodiment. In FIG. 5, components corresponding to respective units in FIG. 4 are given the same reference numerals. The information processing apparatus 1 is configured to include the display unit 110, the imaging unit 120, the ToF sensor 130, the power button 140, the input device 150, a communication unit 160, a storage unit 170, an EC (Embedded Controller) 200, a face detection unit 210, a main processing unit 300, and a power supply unit 400.

The display unit 110 displays display data (images) generated based on system processing executed by the main processing unit 300, processing of an application program running on the system processing, and the like.

The imaging unit 120 captures an image of an object within the predetermined imaging range (angle of view) in the direction (frontward) to face the inner face of the first chassis 10, and outputs the captured image to the main processing unit 300 and the face detection unit 210. For example, the imaging unit 120 includes the visible light camera (RGB camera) for capturing an image using visible light and an infrared camera (IR camera) for capturing an image using infrared light.

Note that the imaging unit 120 may be configured to include either one of the visible light camera and the infrared camera, or may be configured to include both of the visible light camera and the infrared camera.

The ToF sensor 130 emits infrared light forward and receives reflected light of the emitted infrared light to detect a distance to an object (for example, a person) present in front by using the ToF method. For example, the ToF sensor 130 detects the distance to and position (direction) of an object (for example, a person) present within the detection range FoV in the direction (frontward) to face the inner face of the first chassis 10.

The power button 140 outputs, to the EC 200, an operation signal according to a user's operation. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of operation contents.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, and a ROM. The storage unit 170 stores the OS, device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack) to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the intonation processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor for processing image data of a captured image captured by the imaging unit 120. The face detection unit 210 acquires the image data of the captured image captured by the imaging unit 120, and temporarily stores the acquired image data in a memory. The memory in which the image data is stored may be the system memory 304, or an unillustrated memory in the face detection unit 210.

For example, the face detection unit 210 processes the image data of the captured image acquired from the imaging unit 120 to perform face detection processing to detect a face area from the captured image, detect the orientation of a face in the face image of the detected face area, and the like. As the face detection method, the face detection unit 210 can apply any detection method using a face detection algorithm for detecting a face based on facial feature information, trained data (learned model) subjected to machine learning based on the facial feature information, a face detection library, or the like.

Further, the face detection unit 210 performs face authentication processing to authenticate a face in the face image of the detected face area. For example, the face detection unit 210 checks the features of the face image of the detected face area against the features of a pre-registered face image of the authorized user to perform the face authentication processing. The face detection unit 210 transmits, to a chipset 303 of the main processing unit 300, the detection result by the face detection processing, the authentication result by the face authentication processing, and the like.

Note that the face detection unit 210 is operating in a state where at least the high-power detection processing is executed both in the normal operating state and the standby state. For example, when the imaging unit 120 includes both the RGB camera and the IR camera, use of the IR camera can increase the accuracy of the face detection and the accuracy of the face authentication more than use of the RGB camera, but power consumption is higher. Therefore, in the high-power detection processing in the standby state, the face detection unit 210 may perform face detection processing or face authentication processing using the RGB camera, while in the high-power detection processing in the normal operating state, the face detection unit 210 may perform face detection processing or face authentication processing using the IR camera. Note that in the high-power detection processing in the normal operating state, the face detection unit 210 may also perform face detection processing or face authentication processing using both the IR camera and the RGB camera.

The main processing unit 300 is configured to include a CPU (Central Processing Unit) 301, a GPU (Graphic Processing Unit) 302, the chipset 303, and the system memory 304, where processing of various application programs is executable on the OS (Operating System) by system processing based on the OS.

The CPU 301 executes processing based on a BIOS program, processing based on the OS program, processing based on application programs running on the OS, and the like. The CPU 301 controls the operating state of the system under the control of the chipset 303 and the like. For example, the CPU 301 executes boot processing to boot the system from the standby state and make the transition to the normal operating state. Further, after the system is booted from the standby state, the CPU 301 executes login authentication processing to perform user authentication as to whether or not the person is the authorized user. When the function of login authentication by face authentication is set to enabled, the CPU 301 executes user authentication processing by face authentication. On the other hand, when the function of the login authentication by face authentication is set to disabled, the CPU 301 executes user authentication processing other than that by the face authentication (for example, password authentication, PIN authentication, fingerprint authentication, or the like) in the boot processing.

When determining that the person is the authorized user in the user authentication processing, the CPU 301 allows the person to use the information processing apparatus 1 (allows the login), and makes the transition to the normal operating state. On the other hand, when determining that the person is not the authorized user in the user authentication processing, the CPU 301 continues waiting for authentication without allowing the use (without allowing the login).

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection result by face detection processing acquired from the face detection unit 210, the authentication result by the face authentication processing, and the like. Further, the chipset 303 acquires, from the ToF sensor 130, the detection results of the distance to and position (direction) of an object (for example, a person) present within the detection range FoV. For example, the chipset 303 executes HPD processing and the like based on information acquired from the face detection unit 210 or the ToF sensor 130.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may also be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating. In the standby state, at least only functions required for HPD processing are operating.

[Functional Configuration of Information Processing Apparatus]

Next, the functional configuration of HPD processing by the intonation processing apparatus 1 will be described in detail.

FIG. 6 is a schematic block diagram illustrating an example of the functional configuration of the information processing apparatus 1 according to the present embodiment. The information processing apparatus 1 includes a system processing unit 310 and an HPD processing unit 330.

The HPD processing unit 330 is a functional component to execute HPD processing by processing of the chipset 303. For example, the HPD processing unit 330 includes a detection processing selection unit 331, a person detection unit 332, and a state determination unit 333.

The detection processing selection unit 331 selects either one of the low-power detection processing and the high-power detection processing as detection processing when detecting the presence of a person. For example, when detecting the presence of a person in the standby state, the detection processing selection unit 331 selects the low-power detection processing and stops the high-power detection processing. Further, when a person is detected by the low-power detection processing, the detection processing selection unit 331 selects the high-power detection processing to switch from the low-power detection processing to the high-power detection processing.

Further, in the normal operating state, the detection processing selection unit 331 selects the low-power detection processing or the high-power detection processing depending on the state of the detected person. For example, when the motion of the detected person is the predetermined threshold value or more, the detection processing selection unit 331 selects the high-power detection processing, while when the motion of the detected person is less than the predetermined threshold value, the detection processing selection unit 331 stops the high-power detection processing and selects the low-power detection processing.

The person detection unit 332 uses the detection processing selected by the detection processing selection unit 331 between the low-power detection processing and the high-power detection processing to detect the presence or absence of a person within the detection range FoV. For example, in the low-power detection processing, the person detection unit 332 detects the presence or absence of a person within the detection range FoV based on the detection result by the ToF sensor 130. Further, in the high-power detection processing, the person detection unit 332 detects the presence or absence of a person within the detection range FoV based on the detection result by the face detection processing acquired from the face detection unit 210.

As an example, when a person present within the detection range FoV is detected by the low-power detection processing in the standby state, the person detection unit 332 transmits, to the system processing unit 310, information indicating that the person is present (Presence=true) as an instruction to boot the system from the standby state.

Further, in the normal operating state after the system is booted (in the state where the system is booted), the person detection unit 332 detects a person present within the detection range FoV by the high-power detection processing, and when the person present within the detection range FoV is no longer detected, the person detection unit 332 transmits, to the system processing unit 310, intonation indicating that the person is not present (Presence=false) as an instruction to cause the system to make the transition from the normal operating state to the standby state.

Further, in the high-power detection processing, the person detection unit 332 may also acquire information on the orientation of a face of the person detected within the detection range FoV based on the detection result by the face detection processing acquired from the face detection unit 210. For example, when the orientation of the face of the person is forward, the person detection unit 332 may transmit, to the system processing unit 310, information (Attention) indicating such a state that the person is looking toward (paying attention to) the intonation processing apparatus 1. On the other hand, when the orientation of the face of the person is sideways, the person detection unit 332 may transmit, to the system processing unit 310, information (No attention) indicating such a state that the person is not looking toward (not paying attention to) the information processing apparatus 1.

Further, in the high-power detection processing, the person detection unit 332 may acquire the result of face authentication of the person detected within the detection range FoV (the result of whether or not the person is the authorized user) based on the detection result by the face detection processing acquired from the face detection unit 210. For example, when the person present within the detection range FoV is detected in the standby state, the person detection unit 332 may transmit, to the system processing unit 310, information indicating that the person is present (Presence=true) as an instruction to boot the system from the standby state only when the person is the authorized user. Further, when any person other than the authorized user is detected within the detection range FoV in the normal operating state, the person detection unit 332 may transmit, to the system processing unit 310, information indicating that any person other than the authorized user is detected (Non-user detected).

Based on the person detection result by the person detection unit 332, the state determination unit 333 detects a state of the person present within the detection range FoV. For example, the state determination unit 333 detects the motion of the person present within the detection range FoV, and determines whether or not the detected motion of the person is the predetermined threshold value or more. When the person detection unit 332 is detecting the person by the low-power detection processing, the state determination unit 333 determines whether or not the motion of the person is the predetermined threshold value or more based on a change in the distance to or position (direction) of the person. On the other hand, when the person detection unit 332 is detecting the person by the high-power detection processing, the state determination unit 333 determines whether or not the motion of the person is the predetermined threshold value or more based on a change in the size of the face area or the orientation of the face.

In the normal operating state, based on the determination result of this state determination unit 333, the detection processing selection unit 331 described above selects the high-power detection processing when the motion of the person is the predetermined threshold value or more, or stops the high-power detection processing and selects the low-power detection processing when the motion of the person is less than the predetermined threshold value.

The system processing unit 310 is a functional component implemented by the CPU 301 executing processing by the BIOS and the OS. For example, the system processing unit 310 includes an operation control unit 311 as a functional component by the OS processing.

The operation processing unit 311 controls the operating state of the system. For example, the operation control unit 311 controls the operating state of the system to the normal operating state, the standby state, or the like under the control of the HPD processing unit 330. As an example, when acquiring, from the HPD processing unit 330, the information indicating that the person is present (Presence=true) as the instruction to boot the system from the standby state, the operation processing unit 311 boots the operating state of the system from the standby state. Further, when acquiring, from the HPD processing unit 330, the information indicating that the person is not present (Presence=false) as the instruction to cause the system to make the transition from the normal operating state to the standby state, the operation control unit 311 causes the operating state of the system to make the transition from the normal operating state to the standby state.

Further, in the normal operating state, when acquiring, from the HPD processing unit 330, the information indicating that the person present within the detection range FoV is not looking toward (not paying attention to) the information processing apparatus 1 (No attention), the operation control unit 311 may reduce the brightness of the display unit 110 (screen brightness). Thus, power consumed wastefully can be suppressed in the state where the user is not looking toward the information processing apparatus 1.

Further, in the normal operating state, when acquiring, from the HPD processing unit 330, the information indicating that any person other than the authorized user is detected within the detection range FoV (Non-user detected), the operation control unit 311 may display, on the display unit 110, an alarm display to alarm peeping by another person. Thus, the contents being displayed on the screen can be prevented from being seen by any person other than the user (authorized user).

[Operation of HPD Control Processing]

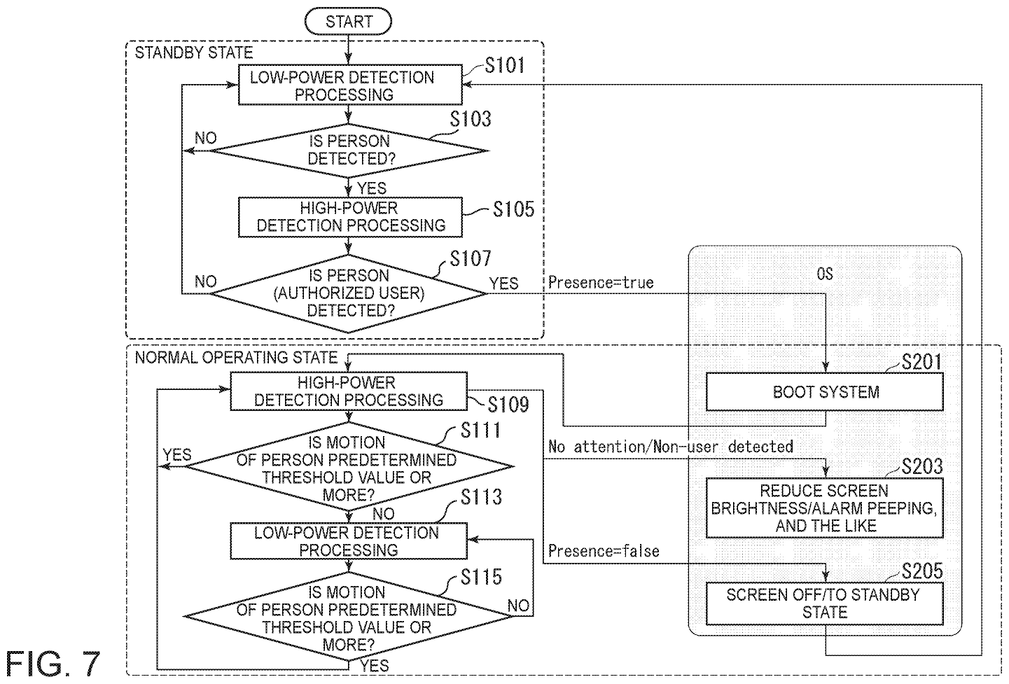

Referring next to FIG. 7, the operation of HPD control processing in which the information processing apparatus 1 switches between the low-power detection processing and the high-power detection processing in the HPD processing to control the operating state of the system will be described.

FIG. 7 is a flowchart illustrating an example of the HPD control processing according to the present embodiment.

(Step S101) In the standby state, the HPD processing unit 330 selects the low-power detection processing to detect the presence or absence of a person within the detection range FoV in front of the information processing apparatus 1 by the low-power detection processing. Then, the HPD processing unit 330 proceeds to a process in step S103.

(Step S103) The HPD processing unit 330 determines whether or not a person present within the detection range FoV is detected by the low-power detection processing. When determining that any person present within the detection range FoV is not detected (NO), the HPD processing unit 330 continues the process in step S101 to continuously perform the low-power detection processing. On the other hand, when determining that a person present within the detection range FoV is detected ((YES), the HPD processing unit 330 proceeds to a process in step S105.

(Step S105) The HPD processing unit 330 executes the high-power detection processing to switch from the low-power detection processing to the high-power detection processing. The HPD processing unit 330 detects the presence or absence of the authorized user based on the face authentication result of the person present within the detection range FoV by the high-power detection processing. Then, the HPD processing unit 330 proceeds to a process in step S107.

(Step S107) The HPD processing unit 330 determines whether or not the authorized user is present within the detection range FoV by the high-power detection processing. When determining that the authorized user is not detected within the detection range FoV (NO), the HPD processing unit 330 returns to the process in step S101 to stop the high-power detection processing and switch from the high-power detection processing to the low-power detection processing. On the other hand, when determining that the authorized user is detected within the detection range FoV (YES), the HPD processing unit 330 transmits, to the system processing unit 310, the information indicating that the person (authorized user) is present (Presence=true).

(Step S201) When acquiring, from the HPD processing unit 330, the information indicating that the person is present (Presence=true), the system processing unit 310 boot the operating state of the system from the standby state. Then, for example, after performing login authentication, the system processing unit 310 makes the transition to the normal operating state.

(Step S109) In the normal operating state, the HPD processing unit 330 first selects the high-power detection processing. For example, the HPD processing unit 330 detects the presence or absence of a person within the detection range FoV by the high-power detection processing. For example, when a person is detected within the detection range FoV, the HPD processing unit 330 acquires, from the face detection unit 210, information on the orientation of a face of the detected person, and when the orientation of the face of the person is forward, the HPD processing unit 330 proceeds to a process in step S111.

(Step S111) Based on the detection result of the person in step S109, the HPD processing unit 330 detects a state of the person present within the detection range FoV. For example, the HPD processing unit 330 detects the motion of the person present within the detection range FoV, and determines whether or not the detected motion of the person is the predetermined threshold value or more. When determining that the detected motion of the person is the predetermined threshold value or more (YES), the HPD processing unit 330 returns to step S109 to continue the high-power detection processing. On the other hand, when determining that the detected motion of the person is less than the predetermined threshold value (NO), the HPD processing unit 330 proceeds to a process in step S113.

(Step S113) When the motion of the person is small, since the state of the person (the position of the person, the orientation of the face, and the like) is stable, the HPD processing unit 330 stops the high-power detection processing and switches from the high-power detection processing to the low-power detection processing. The HPD processing unit 330 detects the person present within the detection range FoV by the low-power detection processing, and proceeds to a process in step S115.

(Step S115) The HPD processing unit 330 detects the motion of the person present within the detection range FoV by the low-power detection processing, and determines whether or not the detected motion of the person is the predetermined threshold value or more. When determining that the detected motion of the person is less than the predetermined threshold value (NO), the HPD processing unit 330 returns to step S113 to continue the low-power detection processing. On the other hand, When determining that the detected motion of the person is the predetermined threshold value or more (YES), the HPD processing unit 330 returns to step S109 to execute the high-power detection processing and switch from the low-power detection processing to the high-power detection processing.

Note that when the orientation of the face of the person detected within the detection range FoV is sideways in step S109, the HPD processing unit 330 transmits, to the system processing unit 310, the information indicating that the person is not looking toward (not paying attention to) the information processing apparatus 1 (No attention). Further, when any person other than the authorized user is detected within the detection range FoV in step S109, the HPD processing unit 330 transmits, to the system processing unit 310, the information indicating that any person other than the authorized user is detected (Non-user detected).

(Step S203) When acquiring, from the HPD processing unit 330, the information indicating that the person is not looking toward (not paying attention to) the information processing apparatus 1 (No attention), the system processing unit 310 reduces the brightness of the display unit 110 (screen brightness). Further, when acquiring, from the HPD processing unit 330, the information indicating that any person other than the authorized user is detected (Non-user detected), the system processing unit 310 displays, on the display unit 110, an alarm display to alai peeping by another person.

Further, in step S109, when the person is no longer detected within the detection range FoV (when the leave of the person is detected), the HPD processing unit 330 transmits, to the system processing unit 310, the information indicating that the person is not present (Presence=false). Note that when the authorized user is no longer detected within the detection range FoV (when the leave of the authorized user is detected), the HPD processing unit 330 may transmit, to the system processing unit 310, the information indicating that the person is not present (Presence=false).

(Step S205) When acquiring, from the HPD processing unit 330, the information indicating that the person is not present (Presence=false), the system processing unit 310 controls the display of the display unit 110 to be turned off (screen OFF). Then, after a state of no input (no operation) has passed for a certain amount of time by the function of a sleep timer of the OS, the system processing unit 310 makes the transition to the standby state and returns to the process in step S101.

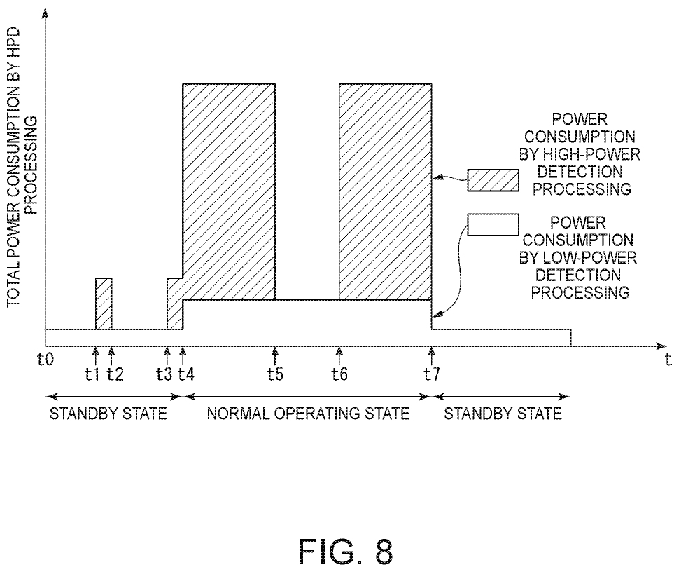

Referring next to FIG. 8, power consumption reduction effects by switching control between the low-power detection processing and the high-power detection processing using the HPD control processing in FIG. 7 will be described.

FIG. 8 is a graph illustrating an example of power consumption changes in the HPD processing according to the present embodiment. In this figure, the vertical axis denotes total power consumption by the HPD processing (the low-power detection processing and the high-power detection processing) and the horizontal axis denotes time, which indicates changes in power consumption according to switching between the low-power detection processing and the high-power detection processing. Further, hatched areas in the total power consumption by the HPD processing indicate power consumption by the high-power detection processing, and an unhatched area indicates power consumption by the low-power detection processing. The operating state of the system is the standby state at time t0 to time t4 and after time t7, and the normal operating state from time t4 to time t7.

First, in the standby state, the low-power detection processing is selected from time t0 to time t1, and the high-power detection processing is stopped (corresponding to step S101 and step S103 in FIG. 7). Therefore, power consumption by the HPD processing is only power consumption by the low-power detection processing.

At time t1, when a person present within the detection range FoV is detected by the low-power detection processing (corresponding to YES in step S103 of FIG. 7), the high-power detection processing is executed, and power consumption by the high-power detection processing is added to the power consumption by the low-power detection processing (corresponding to step S105 and step S107 in FIG. 7).

At time t2, when the authorized user is not detected within the detection range FoV by the high-power detection processing (corresponding to NO in step S107 of FIG. 7), the high-power detection processing is stopped and returned to the low-power detection processing. Therefore, the power consumption by the HPD processing is only the power consumption by the low-power detection processing.

At time t3, when the person present within the detection range FoV is detected again by the low-power detection processing (corresponding to YES in step S103 of FIG. 7), the high-power detection processing is executed, and power consumption by the high-power detection processing is added to the power consumption by the low-power detection processing (corresponding to step S105 and step S107 in FIG. 7).

At time t4, when the authorized user is detected within the detection range FoV by the high-power detection processing (corresponding to YES in step S107 of FIG. 7), the system is booted from the standby state, and the transition to the normal operating state is made (corresponding to step S201 in FIG. 7). In the normal operating state, the power consumption by the HPD processing is a value obtained by adding the power consumption by the high-power detection processing to the power consumption by the low-power detection processing (corresponding to step S109 and step S111 in FIG. 7).

Note that the power consumption by the low-power detection processing and the power consumption by the high-power detection processing are both higher in the normal operating state than those in the standby state. This is because the functions (for example, the detection of the motion of the person, and the like) not supported in the standby state are executed in the normal operating state. Further, in the high-power detection processing, the power consumption is also higher in the normal operating state than that in the standby state, for example, by the fact that the RGB camera is used in the standby state and the IR camera is used in the normal operating state.

In the normal operating state, when it is detected at time t5 that the motion of the person is less than the predetermined threshold value by the high-power detection processing (corresponding to NO in step S111 of FIG. 7), the high-power detection processing is stopped and switched to the low-power detection processing. Therefore, the power consumption by the HPD processing is only the power consumption by the low-power detection processing (corresponding to step S113 and step S115 in FIG. 7).

At time t6, when it is detected that the motion of the person is the predetermined threshold value or more by the low-power detection processing (corresponding to YES in step S115 of FIG. 7), the high-power detection processing is executed, and the power consumption by the high-power detection processing is added to the power consumption by the low-power detection processing (corresponding to step S109 and step S111 in FIG. 7).

At time t7, when the leave of the person (authorized user) is detected by the high-power detection processing, the transition of the system from the normal operating state to the standby state is made (corresponding to step S205 in FIG. 7). Further, the high-power detection processing is stopped and switched to the low-power detection processing. Therefore, the power consumption by the HPD processing is only the power consumption by the low-power detection processing (corresponding to step S101 and step S103 in FIG. 7).

Thus, according to the present embodiment, power consumption can be reduced by mainly selecting the low-power detection processing in the standby state, and even in the normal operating state, power consumption can be reduced by selecting the high-power detection processing only when needed and selecting the low-power detection processing otherwise.

### Summary of Embodiment

As described above, the information processing apparatus 1 according to the present embodiment includes the ToF sensor 130 (an example of a first detection device) for detecting a person within the detection range FoV (an example of a predetermined direction) in front of the information processing apparatus 1, and the imaging unit 120 (an example of a second detection device) for detecting the person in the detection range FoV with higher power consumed than that of the ToF sensor 130. Further, the information processing apparatus 1 includes the system memory 304 (an example of a memory) which temporarily stores a program of the system (for example, the OS), and a processor such as the CPU 301, the chipset 303, and the face detection unit 210. The information processing apparatus 1 controls the operating state of the system by executing the program of the system (for example, the OS). For example, the information processing apparatus 1 boots the system from the standby state based on the low-power detection processing (an example of first detection processing) to detect a person within the detection range FoV using the ToF sensor 130. Further, in the state where the system is booted (for example, in the normal operating state), the information processing apparatus 1 performs the high-power detection processing (an example of second detection processing) to detect the person within the detection range FoV using the imaging unit 120, and stops the high-power detection processing using the imaging unit 120 depending on the state of the detected person to detect the person within the detection range FoV by the low-power detection processing using the ToF sensor 130.

Thus, since the information processing apparatus 1 performs the high-power detection processing only when needed even in the normal operating state after booting the system in addition to in the standby state, the person can be detected accurately while reducing power consumption.

For example, in the normal operating state, when the motion of the detected person is the predetermined threshold value or more, the information processing apparatus 1 detects the person within the detection range FoV by the high-power detection processing using the imaging unit 120, while when the motion of the detected person is less than the predetermined threshold value, the information processing apparatus 1 stops the high-power detection processing using the imaging unit 120 and performs the low-power detection processing to detect the person within the detection range FoV by the low-power detection processing using the ToF sensor 130.

Thus, in the normal operating state, when the motion of the person is large, since the state of the person (the position of the person, the orientation of the face, and the like) is likely to change, the information processing apparatus 1 performs the high-power detection processing to be able to detect the change, while when the motion of the person is small, since the state of the person (the position of the person, the orientation of the face, and the like) is stable, the information processing apparatus 1 performs the low-power detection processing. Thus, the person can be detected accurately while reducing power consumption.

Further, in the state where the high-power detection processing is stopped in the normal operating state, when the motion of the person detected by the low-power detection processing is the predetermined threshold value or more, the information processing apparatus 1 executes the high-power detection processing using the imaging unit 120 to detect the person within the detection range FoV.

Thus, in the state where the high-power detection processing is stopped in the normal operating state, the information processing apparatus 1 can monitor the motion of the person by the low-power detection processing to switch to the high-power detection processing as needed. Therefore, the person can be detected accurately while reducing power consumption.

Note that when the high-power detection processing is pertained to detect the person within the detection range FoV using the imaging unit 120, the information processing apparatus 1 may also stop the low-power detection processing using the ToF sensor 130.

Thus, the information processing apparatus 1 can reduce power consumption when performing the high-power detection processing.

Note that a radar sensor may also be used instead of the ToF sensor 130 for measuring the distance to an object within the detection range FoV. In the low-power detection processing, the information processing apparatus 1 measures the distance to the object within the detection range FoV using the ToF sensor 130 or the radar sensor to detect a person.

Thus, in the low-power detection processing, the information processing apparatus 1 can reduce power consumption compared to the high-power detection processing by face detection.

Further, the imaging unit 120 includes an imaging element (imaging sensor) which images the detection range FoV. In the high-power detection processing, the information processing apparatus 1 detects a face area (an area of a face image) from among captured images obtained by imaging the detection range FoV using the imaging unit 120 to detect a person.

Thus, in the high-power detection processing, the information processing apparatus 1 can increase the detection accuracy of the person by face detection more than that in the low-power detection processing using the ToF sensor 130 or the radar sensor.

Further, in the high-power detection processing, the information processing apparatus 1 may further detect the orientation of the face in the detected face image to control the operating state of the system according to the detected orientation of the face.

Thus, the intonation processing apparatus 1 can pertain the high-power detection processing only when the motion of the person is large to detect the orientation of the face incapable of being detected in the low-power detection processing using the ToF sensor 130 or the radar sensor. Therefore, the information processing apparatus 1 can also reduce the screen brightness, for example, in the state where the person is not looking toward (not paying attention to) the information processing apparatus 1 while reducing power consumption.

Further, in the high-power detection processing, the information processing apparatus 1 may perform face authentication processing based on the detected face image to control the operating state of the system according to the authentication result.

Thus, in the high-power detection processing, the information processing apparatus 1 can perform the face authentication processing incapable of being performed in the low-power detection processing using the ToF sensor 130 or the radar sensor. Therefore, when a person is detected, the information processing apparatus 1 can control the operating state of the system according to whether or not the person is the authorized user.

Further, a control method for the information processing apparatus 1 according to the present embodiment includes: a step of causing the intonation processing apparatus 1 to boot the system from the standby state based on the low-power detection processing (the example of the first detection processing) for detecting a person within the detection range FoV using the ToF sensor 130; and a step of causing the information processing apparatus 1 to perform the high-power detection processing (the example of the second detection processing) for detecting the person within the detection range FoV using the imaging unit 120 in the state where the system is booted (for example, in the normal operating state), and to stop the high-power detection processing using the imaging unit 120 depending on the state of the detected person in order to perform the low-power detection processing for detecting the person within the detection range FoV by the low-power detection processing using the ToF sensor 130.

Thus, since the information processing apparatus 1 performs the high-power detection processing only when needed even in the normal operating state after booting the system in addition to in the standby state, the person can be detected accurately while reducing power consumption.

While the embodiment of this invention has been described in detail above with reference to the accompanying drawings, the specific configurations are not limited to those in the embodiment described above, and design changes without departing from the scope of this invention shall also be included. For example, the respective components described in the above embodiment can be combined arbitrarily.

Further, in the aforementioned embodiment, the configuration example in which the imaging unit 120 and the ToF sensor 130 are built in the information processing apparatus 1 is described, but the present invention is not limited to this example. For example, the imaging unit 120 or the ToF sensor 130 does not have to be built in the information processing apparatus 1, which may also be attachable to the intonation processing apparatus 1 (for example, onto any of the side faces 10a, 10b, 10c, and the like) and communicably connected to the information processing apparatus 1 wirelessly or by wire as an external accessory of the information processing apparatus 1.

Further, the CPU 301 and the chipset 303 may be configured as individual processors, or may be integrated as one processor.

Further, in the aforementioned embodiment, the example in which the face detection unit 210 is provided separately from the chipset 303 is illustrated, but some or all of the functions of the face detection unit 210 may be provided by the chipset 303, or provided by a processor integrated with the chipset 303. Further, some or all of the functions of the face detection unit 210 may be provided by the EC 200. Further, in the aforementioned embodiment, the example in which the chipset 303 includes the HPD processing unit 330 is illustrated, but some or all of the functions of the HPD processing unit 330 may be provided by the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the above-described embodiment may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned embodiment is not limited to the PC, the tablet terminal, the smartphone, or the like, which may also be a game machine, a multi-media terminal, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF SYMBOLS

1 information processing apparatus
10 first chassis
20 second chassis
15 hinge mechanism
110 display unit
120 imaging unit
130 ToF sensor
140 power button
150 input device
151 keyboard
153 touch pad
160 communication unit
170 storage unit
200 EC
210 face detection unit
300 main processing unit
301 CPU
302 GPU
303 chipset
304 system memory
310 system processing unit
311 operation control unit
330 HPD processing unit
331 detection processing selection unit
332 person detection unit
333 state determination unit
400 power supply unit

What is claimed is:

1. An information processing apparatus comprising:
a first detection device for detecting a person in a predetermined direction;
a second detection device for detecting the person in the predetermined direction with higher power consumed than that of the first detection device;
a memory which temporarily stores a program of a system; and
a processor which controls an operating state of the system by executing the program, wherein
the processor boots the system from a standby state based on first detection processing to detect the person in the predetermined direction using the first detection device, and
in a state where the system is booted, the processor performs second detection processing to detect the person in the predetermined direction using the second detection device, and stops the second detection processing using the second detection device depending on a state of the detected person to detect the person in the predetermined direction by the first detection processing using the first detection device.

2. The information processing apparatus according to claim 1, wherein
when motion of the detected person is a predetermined threshold value or more in the state where the system is booted, the processor detects the person in the predetermined direction by the second detection processing using the second detection device, or
when the motion of the detected person is less than the predetermined threshold value, the processor stops the second detection processing using the second detection device to detect the person in the predetermined direction by the first detection processing using the first detection device.

3. The information processing apparatus according to claim 2, wherein after the second detection processing is stopped in the state where the system is booted, when the motion of the person detected by the first detection processing is the predetermined threshold value or more, the processor executes the second detection processing using the second detection device to detect the person in the predetermined direction.

4. The information processing apparatus according to claim 1, wherein the processor stops the first detection processing using the first detection device when detecting the person in the predetermined direction by the second detection processing using the second detection device.

5. The information processing apparatus according to claim 1, wherein
the first detection device includes a ToF (Time of Flight) sensor or a radar sensor which measures a distance to an object in the predetermined direction, and
in the first detection processing, the processor detects a person by measuring the distance to the object in the predetermined direction using the first detection device.

6. The information processing apparatus according to claim 1, wherein
The second detection device includes an imaging sensor which images the predetermined direction, and
In the second detection processing, the processor detects an area of a face image from among captured images obtained by imaging the predetermined direction using the second detection device to detect a person.

7. The information processing apparatus according to claim 6, wherein in the second detection processing, the processor further detects orientation of a face in the detected face image to control the operating state of the system according to the detected orientation of the face.

8. The information processing apparatus according to claim 6, wherein in the second detection processing, the processor performs face authentication processing based on the detected face image to control the operating state of the system according to the authentication result.

9. A control method for an information processing apparatus including: a first detection device for detecting a person in a predetermined direction; a second detection device for detecting the person in the predetermined direction with higher power consumed than that of the first detection device; a memory which temporarily stores a program of a system; and a processor which controls an operating state of the system by executing the program, the control method comprising:
a step of causing the processor to boot the system from a standby state based on first detection processing to detect the person in the predetermined direction using the first detection device; and
a step of causing the processor to perform second detection processing in order to detect the person in the predetermined direction using the second detection device in a state where the system is booted, and to stop the second detection processing using the second detection device depending on a state of the detected person in order to detect the person in the predetermined direction by the first detection processing using the first detection device.
